(19) United States
(12) Patent Application Publication
(10) Pub. No.: US 2012/0156959 A1
(43) Pub. Date: Jun. 21, 2012

(54) GAME CALL

(76) Inventor: John Kennedy, Kalamazoo, MI (US)

(21) Appl. No.: 13/330,111

(22) Filed: Dec. 19, 2011

Related U.S. Application Data
(60) Provisional application No. 61/425,004, filed on Dec. 20, 2010.

(51) Int. Cl. A01M 31/00

(52) U.S. Cl. 446/208

(57) ABSTRACT

A hand-held and mouth-operated game call includes a housing assembly defining a flow path, a reed assembly positioned within the housing assembly and a flow path constrictor positioned within the flow path for manipulating the flow path. The flow path constrictor is manually adjustable at an exterior of the housing assembly.

### CROSS REFERENCE TO RELATED APPLICATIONS

This is a non-provisional application based upon U.S. Provisional Patent Application Ser. No. 61/425,004, entitled “GAME CALL”, filed Dec. 20, 2010, which is incorporated herein by reference.

### BACKGROUND OF THE INVENTION

1. Field of the Invention

The present invention relates to game call, and, more particularly, to a deer call.

2. Description of the Related Art

The sport of wild game hunting has grown in popularity over the years, in particular with the explosion of, for example, the deer population. Enthusiasm for the sport of hunting has resulted in the development of a vast number of hunting accessories including blinds, stands, decoys and game calls. Wild game calls are utilized to attract wildlife to a closer proximity, strategically improving the chances of a successful hunt. The calls produced by wildlife vary widely in pitch and spectral content dependent upon the genus, species, sex and even age of the animal.

What is needed in the art is a game call capable of simply and selectively producing a wide range of calls of varying pitch and spectral content.

### SUMMARY OF THE INVENTION

The present invention provides a hand-held and mouth-operated game call including a housing assembly which defines a flow path, a reed assembly positioned within the housing assembly and a flow path constrictor positioned within the flow path for manipulating the flow path. The flow path constrictor of the game call of the present invention is manually adjustable at an exterior of the housing assembly.

The invention in another form is directed to a hand-held and mouth-operated game call including a housing assembly defining a flow path, a reed assembly positioned within the housing assembly and a flow path constrictor for manually manipulating the flow path. The flow path constrictor is positioned within the flow path and downstream from the reed assembly in a direction of air flow.

A third embodiment of the present invention provides a hand-held and mouth-operated game call including a housing assembly which defines a flow path and a reed assembly positioned within the housing assembly. The housing assembly includes a first rigid portion, a second flexible portion and a third rigid portion. The second flexible portion is positioned between and coupled with the first portion and the third portion of the housing assembly.

Advantageously, the present invention allows the user to selectively produce and effectively mimic the natural calls of deer through the simple manipulation of a flow path constrictor.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of a first embodiment of the deer call according to the present invention;

FIG. 2 is view of the deer call according to FIG. 1, illustrating the internal flow path in phantom;

FIG. 3 is a perspective view of a second embodiment of the deer call according to the present invention;

FIG. 4 is a view of the deer call according to FIG. 3, illustrating the internal flow path in phantom;

FIG. 5 is an end view of the sliding pitch manipulation device within the housing assembly of the game call of FIG. 3;

FIG. 6 is a side view of a flow path constrictor according to the present invention;

FIG. 7 is a side view of a first embodiment of a reed assembly for the game call of the present invention;

FIG. 8 is an end view of the reed assembly of FIG. 7;

FIG. 9 is a side view of a second embodiment of a reed assembly for the game call of the present invention; and

FIG. 10 is a D-ring for the reed assembly of the game call according to the present invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

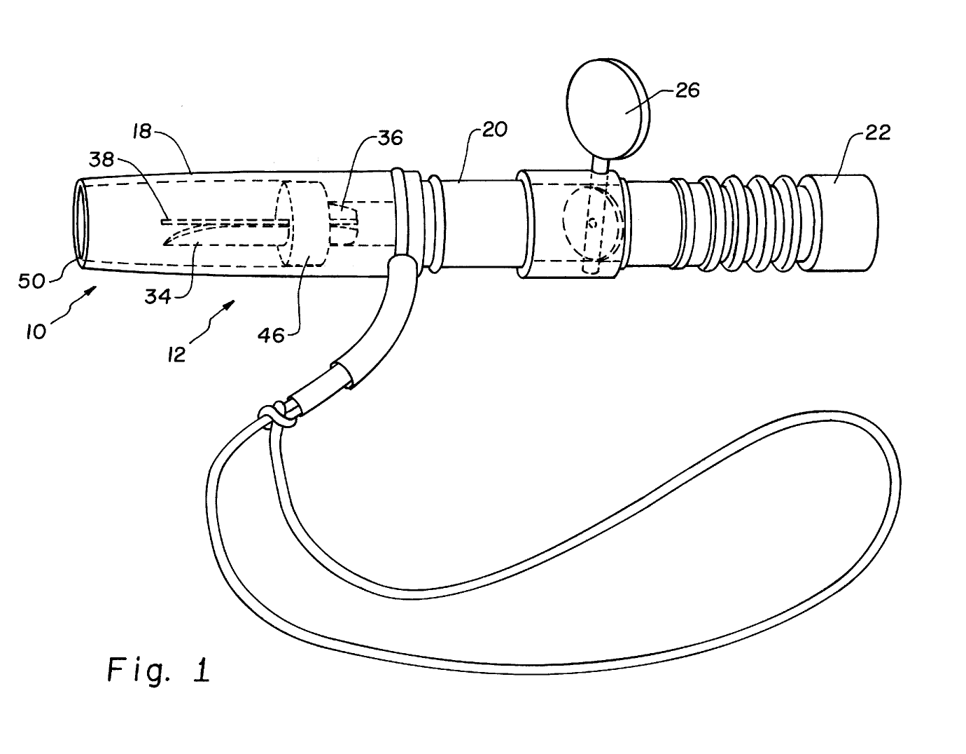

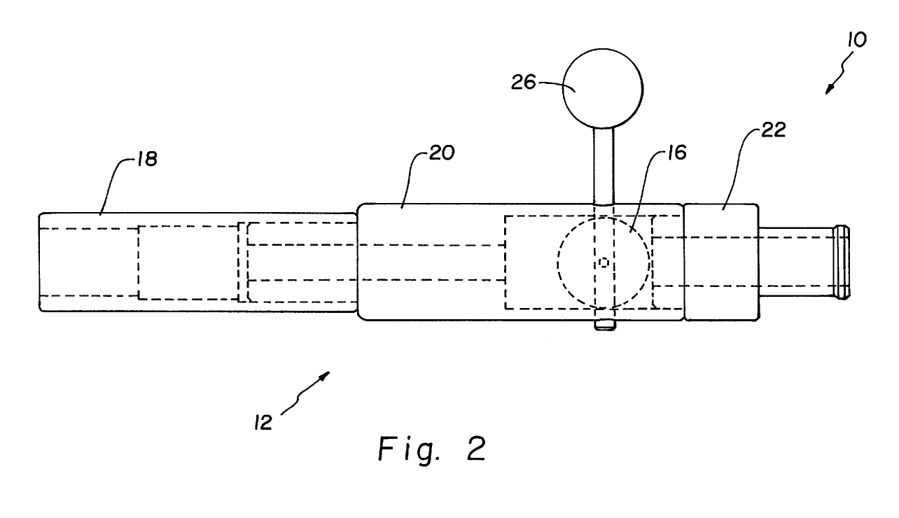

Referring now to the drawings, and more particularly to FIGS. 1 and 2, there is shown hand-held and mouth-operated game call 10, which generally includes housing assembly 12 defining a flow path, reed assembly 14 positioned within housing assembly 12 and flow path constrictor 16 positioned within the flow path for manipulating the flow path. Flow path constrictor 16 is manually adjustable at an exterior of housing assembly 12.

Housing assembly 12 may be formed from a single component or, for example, can include first portion 18 and second portion 20 coupled with first portion 18. Reed assembly 14 is securely positioned within housing assembly 12 and within the flow path. For example, Reed assembly may be securely coupled with second portion 20 and extend into first portion 18. Further, flow path constrictor 16 is positioned downstream of reed assembly 14 in a direction of flow along the flow path. Optionally, game call 10 may also include extension 22 coupled with, for example, second portion 20 of housing assembly 12. In this case, second portion 20 includes a section having a reduced diameter to which extension 22 is coupled. Extension 22 may have a bellows construction and is sufficiently flexible to direct the call produced in any direction. A tether for ease of carrying is secured around housing assembly 12 and may, for example, be worn around the neck of a hunter.

Manually adjustable flow path constrictor 16 is positioned in the flow path defined by housing assembly 12. For example, flow path constrictor 16 may be positioned in second portion 20 of housing assembly 12. In this case, flow path constrictor 16 is positioned downstream from first portion 18 and reed assembly 14 in a direction of air flow. Flow path constrictor may be in any number of forms. According to a first embodiment of the game call of the present invention, flow path constrictor 16 is in the form of a butterfly valve positioned within housing assembly 12 downstream from first portion 18 and reed assembly 14 in the direction of air flow. An actuator 26 extending externally of housing assembly 12 allows for manipulation of flow path constrictor 16 within housing assembly 12 to control the pitch of the call produced.

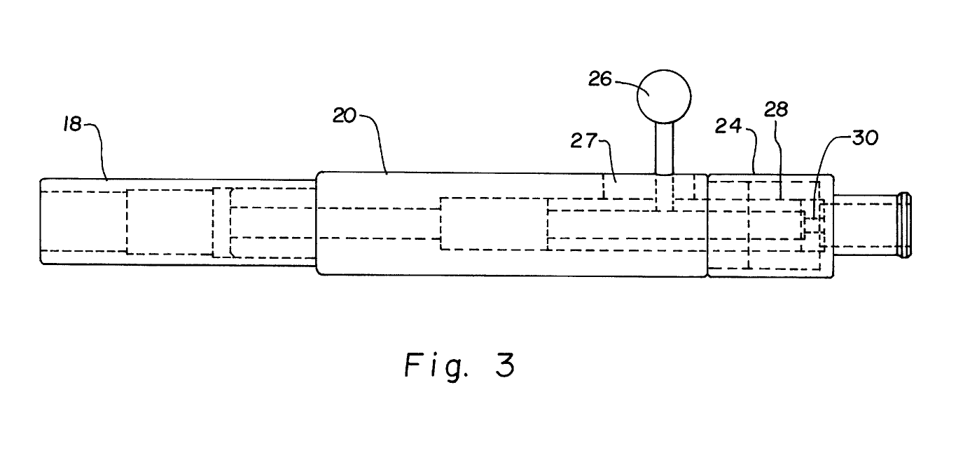

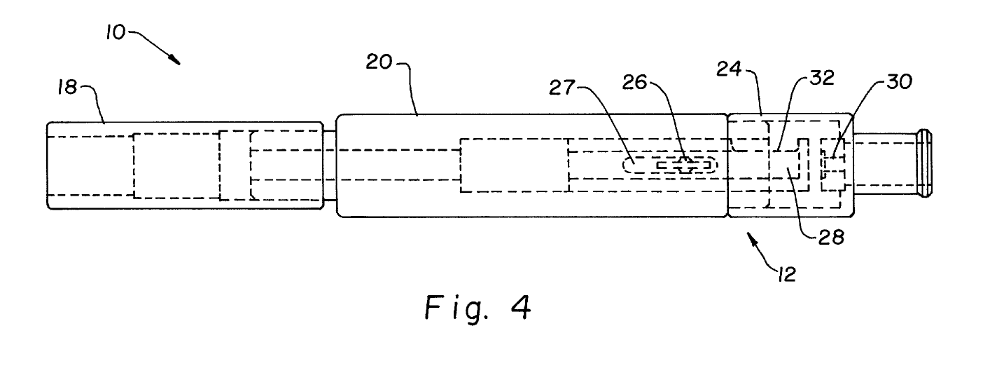

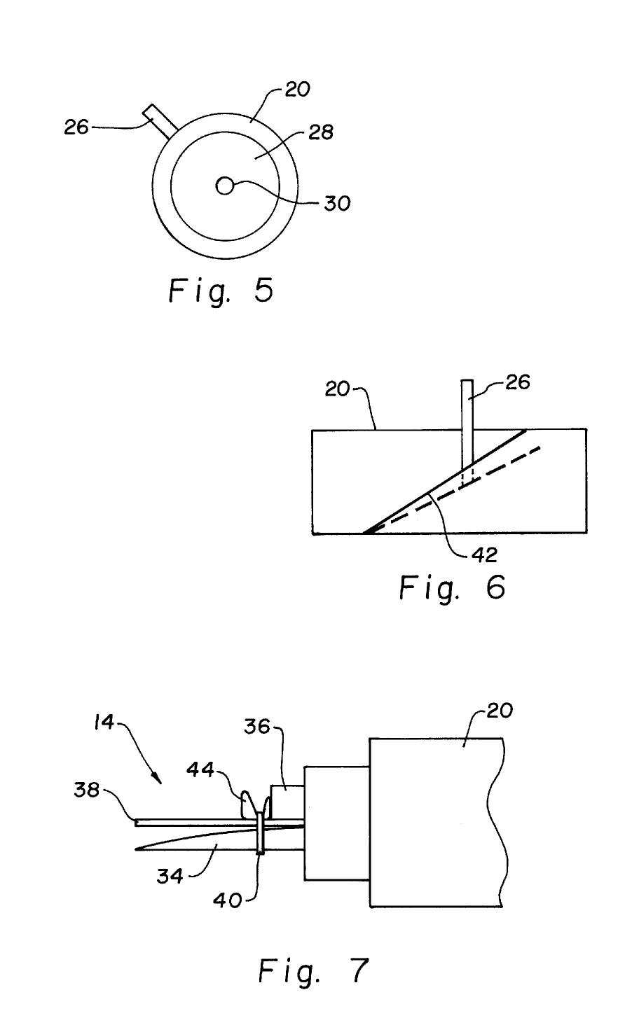

Referring now to FIGS. 3-5, there is shown a second embodiment of the game call according to the present invention including housing assembly 12 defining a flow path, reed assembly 14 and manually sliding pitch manipulation device 28. According to this embodiment of the inventive game call, pitch manipulation device 28 is slidably received within housing assembly 12. More specifically, pitch manipulation device 28 is, for example, slidably received within second portion 20 of housing assembly 12, downstream from first portion 18 in the direction of flow and may extend into third portion 24 of housing assembly 12. Pitch manipulation device 28 may include a bore extending to opening 30 at an end of device 28 distal of first portion 18 in a direction of flow. Second opening 32 is positioned in a side wall of device 28, as illustrated in FIG. 4. Actuator 26 is extends outwardly from housing assembly 12 through elongate opening 27 and is coupled with pitch manipulation device 28. The pitch of the call produced is then manipulated via movement of actuator 26 along elongate opening 27 in a longitudinal direction parallel to the direction of flow.

Referring now to FIG. 6, there is shown a side view of a portion of a third embodiment of the game call according to the present invention. According to this embodiment of the present invention, flow path constrictor 16 includes rubber flap 42 operatively coupled with and extending at an angle from an inside wall of housing assembly 12 towards a distal end of game call 10. For example, flow path constrictor 16 may extend from an inside wall of second portion 20 toward third portion 24 of housing assembly. The position of rubber flap 42 is manipulated with actuator 26 which extends through a side wall of second portion 20 to contact rubber flap 42. The pitch of the call produced is then manipulated via movement of actuator 26 against rubber flap 42 which thereby opens (shown in phantom) or closes the flow path defined by housing assembly 12.

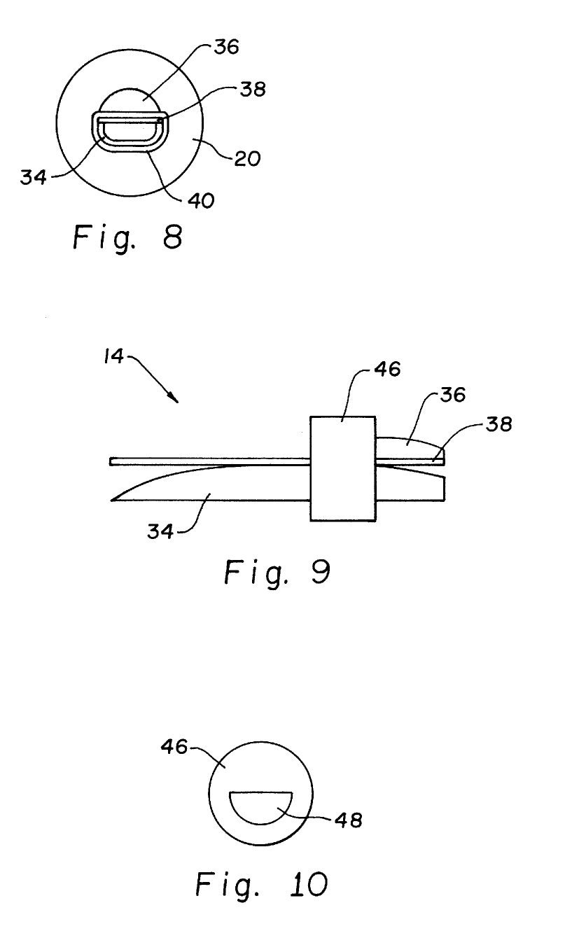

Referring now to FIGS. 7 and 8, there is shown reed assembly 14 of the game call according to the present invention. Reed assembly 14 includes base member 34 and flexible reed 38 which is positioned on top of base member. Optionally top member 36 may be positioned on top of flexible reed 38. D-band 40 is secured around base member 34 and flexible reed 38 and adjacent to optional top member 36. Flexible insert 44 may further be inserted through D-band 40 to further vary the pitch of the call produced. D-band 40 ensures that a predetermined length of flexible reed 38 is free to vibrate against bottom member, thus producing a realistic call. In other words, D-band 40 advantageously secures flexible reed 38 to bottom member in such a manner as to allow even a novice user to produce a realistic call.

Referring now to FIGS. 9 and 10, there is shown an additional embodiment of reed assembly 14 of the game call of the present invention. In this case, reed assembly 14 is securely fixed within housing assembly 12. Flexible reed 38 is positioned on top of base member 34. Both flexible reed 38 and base member 34 are securely coupled with D-ring 46 by positioning base member 34 and flexible reed 38 within aperture 48 of D-ring 46. Beveled top member 36 is positioned on top of flexible reed 38 and abutting D-ring 46. Beveled top member 36 on the side closest to D-ring 46 has a semi-circular cross-section of approximately a half of a circle, the circle being approximately the diameter of the cylindrical bore or flow path in which beveled top member 36 is positioned. The opposite side of beveled top member 36 has a smaller cross-sectional area than the side closest to D-ring 46.

Referring now to FIG. 1, game call 10 is shown including reed assembly 14 with D-ring 46. Reed assembly 14 is securely coupled with second portion 20 of housing assembly 12 such that D-ring 46 abuts second portion 20 and extends into first portion 18 of housing assembly 12 when first portion 18 and second portion 20 are securely coupled together. First portion 18 further includes lip adaptor 50 onto which the mouth of a user is placed.

Advantageously, the game call according to the present invention allows for production of calls with a wide range of pitch variation and direction. Further, the novel reed assembly construction including the D-band or the D-ring in coordination with the flow path constrictor allows even a novice to easily produce effective calls.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A hand-held and mouth-operated game call, comprising:
a housing assembly defining a flow path;
a reed assembly positioned within said housing assembly; and
a flow path constrictor positioned within said flow path for manipulating said flow path, wherein said flow path constrictor is manually adjustable at an exterior of said housing assembly.

2. The game call according to claim 1, said housing assembly further comprising a first portion and a second portion operatively coupled with said first portion, said reed assembly being positioned between said first portion and said second portion and said flow path constrictor positioned downstream of said reed assembly in a direction of flow along said flow path.

3. The game call according to claim 2, further comprising an actuator operatively coupled with said flow path constrictor.

4. The game call according to claim 3, wherein said flow path constrictor is a butterfly valve.

5. The game call according to claim 3, wherein said flow path constrictor is a sliding pitch manipulation device slidingly received within said housing assembly.

6. The game call according to claim 3, wherein said flow path constrictor is a rubber flap extending from an inner wall of said housing assembly.

7. The game call according to claim 6, further comprising an extension having a bellows construction, said extension being operatively coupled with said housing assembly.

8. The game call according to claim 1, wherein said reed assembly includes a base member, a top member having a portion that overlaps said base member, a flexible reed and a d-band, said d-band securing said flexible reed to said base member.

9. The game call according to claim 8, further comprising a flexible insert positioned between said flexible reed and said d-band.

10. The game call according to claim 1, wherein the game call is a deer call.

11. A hand-held and mouth-operated game call, comprising:
a housing assembly defining a flow path;
a reed assembly positioned within said housing assembly; and
a flow path constrictor positioned within said flow path for manipulating said flow path, wherein said flow path constrictor is manually adjustable at an exterior of said housing assembly and is positioned downstream from said reed assembly in a direction of air flow.

12. The game call according to claim 11, wherein said flow path constrictor is a butterfly valve positioned within said housing assembly.

13. The game call according to claim 12, further comprising an actuator extending externally of said housing assembly and operatively coupled with said butterfly valve for manual manipulation of said butterfly valve.

14. The game call according to claim 11, wherein said flow path constrictor is a rubber flap extending from an inner wall of said housing assembly.

15. The game call according to claim 11, said housing assembly further comprising a first portion and a second portion operatively coupled with said first portion, said reed assembly being positioned between said first portion and said second portion and said flow path constrictor positioned downstream of said reed assembly in a direction of air flow along said flow path.

16. The game call according to claim 11, said reed assembly further comprising a base member, a top member, a flexible reed and a D-ring including an aperture configured to receive said base member and said flexible reed.

17. The game call according to claim 16, wherein said first portion includes a lip adapter and is configured to increase in diameter as it progresses toward said second portion.

18. The game call according to claim 17, wherein said reed assembly is securely coupled with said first portion of said housing assembly and extends into said second portion of said housing assembly, said first portion and said second portion being securely coupled.

19. A hand-held and mouth-operated game call, comprising:
a housing assembly defining a flow path and including a first rigid portion, a second flexible portion and a third rigid portion, said second flexible portion positioned between and coupled with said first rigid portion and said third rigid portion; and
a reed assembly positioned within said housing assembly.

20. The game call according to claim 19, wherein said second flexible portion has a bellows construction.
